(19) United States
(12) Patent Application Publication
(10) Pub. No.: US 2014/0013501 A1
(43) Pub. Date: Jan. 16, 2014

(54) Cleansing Implement

(71) Applicants: EVAN CHARLES MURPHY, TRUMBULL, CT (US); LIAM ANTHONY PETER MURRAY, TRUMBULL, CT (US); STUART HARVEY LEE, FOREST HILLS, NY (US); HEATHER FRITZSCHE, YARDLEY, PA (US); JOCHEN RAINER SCHAEPERS, NEW YORK, NY (US)

(72) Inventors: EVAN CHARLES MURPHY, TRUMBULL, CT (US); LIAM ANTHONY PETER MURRAY, TRUMBULL, CT (US); STUART HARVEY LEE, FOREST HILLS, NY (US); HEATHER FRITZSCHE, YARDLEY, PA (US); JOCHEN RAINER SCHAEPERS, NEW YORK, NY (US)

(73) Assignee: CONOPCO, INC., D/B/A UNILEVER, Englewood Cliffs, NJ (US)

(21) Appl. No.: 13/546,017

(22) Filed: Jul. 11, 2012

(51) Int. Cl. A47K 7/02; B29C 65/00; A45D 19/00

(52) U.S. Cl. 4/515; 15/244.4; 132/200; 156/245

(57) ABSTRACT

A personal care implement is disclosed having a flexible, apertured plastic shell and a resilient polymeric mesh sponge material held inside and in pressing engagement within the shell. In use, a sufficient quantity of a suitable liquid cleansing composition is introduced inside the implement. The implement produces copious quantities of lather foam and cleansing with sensory properties of a conventional toilet bar but with none of its disadvantages.

### BACKGROUND

1. Field of the Invention

The invention relates to a skin cleansing implement that is advantageously used with a liquid cleanser.

2. Description of the Related Art

Personal cleansing products have traditionally been marketed in a variety of forms such as toilet bars, creams, lotions, and gels. These formulations have attempted to satisfy a number of criteria to be acceptable to consumers. These criteria include cleansing effectiveness, skin feel, skin mildness and lather volume. Ideal personal cleansers should gently cleanse the skin or hair, cause little or no irritation, and not leave the skin or hair overly dry after frequent use. Consumers who use toilet bars expect certain tactile attributes while cleansing and have heretofore been reluctant to use liquid body washes which typically provide an entirely different tactile feel. Applicants have surprisingly found that an implement could be constructed to mimic the tactile attributes of toilet bars while providing the unique benefits of body washes.

Washing implements combining a plurality of materials are known. For example U.S. Pat. No. 5,915,434 to Juarez issued on Jun. 29, 1999 discloses a body washing and scrubbing device with a pliable cover and an inner core containing small bead-like or ovoid objects. ES 2150868 (A1) to Quiroga Perez published on Dec. 1, 2000 discloses a dispenser sponge for liquids, gels or soaps. The device provides grooves for holding e.g. liquids and a porous surface for dispensing and distributing the contents onto the skin. U.S. Pat. No. 7,318,682 to Anderson issued on Jan. 15, 2008 discloses an apparatus that combines a pouf attached to a squeezable container. When the squeezable container is squeezed, it delivers liquid to the pouf to apply the liquid to the skin of the user. However it was unexpectedly found that the inventive implement solves the problem of providing the combined unique attributes of toilet soap and liquid body wash in personal cleansing.

### SUMMARY OF THE INVENTION

In one aspect of the invention is a cleansing implement for depositing a liquid cleanser on the skin of a user, including but not limited to:
a. an outer shell and a resilient core material held inside and in pressing engagement with the interior of the shell, wherein the shell is composed of a material that is flexible at use temperatures and the core material is composed of polymeric mesh sponge having a plurality of plies of an extruded tubular netting mesh;
b. wherein the shell has a arcuate first surface and an opposed substantially flat second surface, the first and second surfaces each defining a plurality of apertures;
c. wherein the plurality of apertures on the first surface occupy a surface area in the range of about 25 to 75% based on the extent of the total surface area of first surface and the plurality of apertures on the second surface occupies a surface area in the range of about 25 to 75% based on the extent of the total surface area of the second side; and
d. wherein not more than about 70% of the apertures each exceed 40 square mm in area.

In another aspect of the invention is a process of making a cleansing implement including but not limited to the steps of:
a. bonding a flexible foamed plastic sheet with woven fibrous mesh to form a flexible composite sheet;
b. cutting a plurality of apertures in the composite sheet;
c. inserting the composite sheet into a first mold cavity;
d. suspending an inner mold within the first mold cavity and inside of the composite sheet;
e. closing the mold;
f. injecting thermoplastic resin having a Shore A Durometer of at least 15 at a temperature above its melt temperature; and
g. molding the foamed plastic sheet and the thermoplastic resin together to form a flexible shell.

In a further aspect of the invention is a method of cleansing the skin or hair including but not limited to the steps of:
a. providing a cleansing implement as described above;
b. adding at least 3 grams of a liquid cleansing composition containing about 8 to 40% by wt. of total lathering surfactant(s) prior to cleansing the skin or hair;
c. adding water to the implement while manually compressing and releasing the implement to transfer a sufficient quantity of cleansing composition to the polymeric mesh sponges to generate lather; and
rubbing and squeezing the implement simultaneously on the skin.

### BRIEF DESCRIPTION OF THE DRAWINGS

FIG. 1 is a front perspective view of a cleansing implement representing an embodiment of this invention.

FIG. 2 is a top plan view of a cleansing implement representing an embodiment of this invention.

FIG. 3 is a bottom plan view of a cleansing implement representing an embodiment of this invention.

FIG. 4 is a front elevational view of a cleansing implement representing an embodiment of this invention.

FIG. 5 is a cross-sectional view taken along line 8-8 of FIG. 2.

FIG. 6 is a right side elevational view of a cleansing implement representing an embodiment of this invention.

FIG. 7 is a left side elevational view of a cleansing implement representing an embodiment of this invention.

FIG. 8 is a perspective view of a polymeric mesh sponge representing a component of resilient core 50 as one embodiment of this invention.

### DETAILED DESCRIPTION OF THE INVENTION

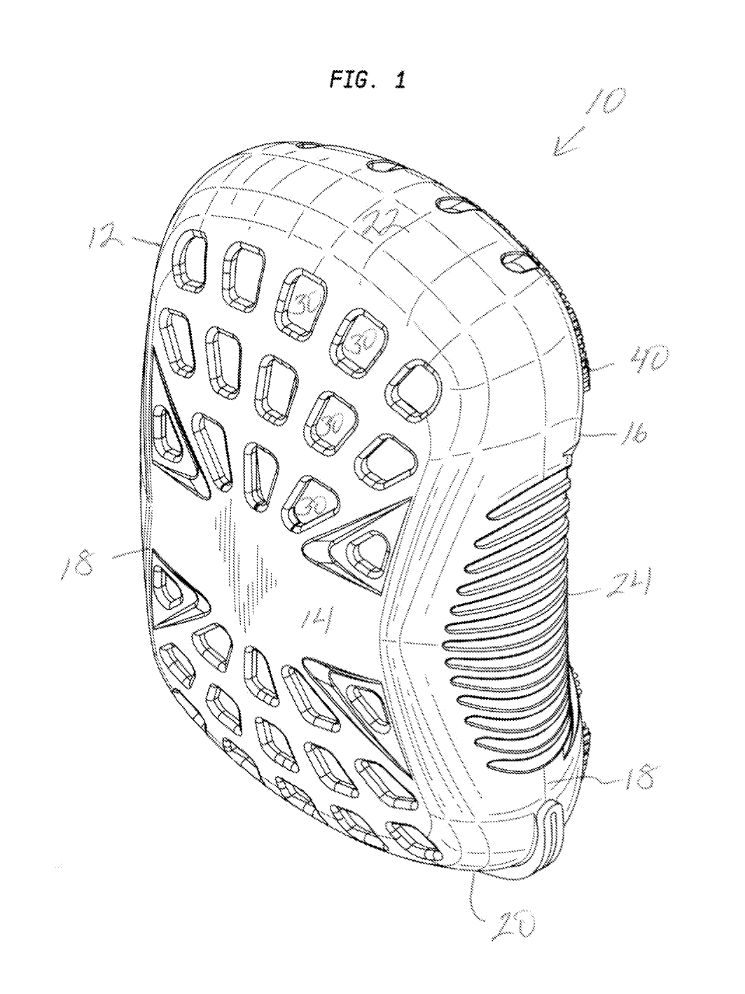

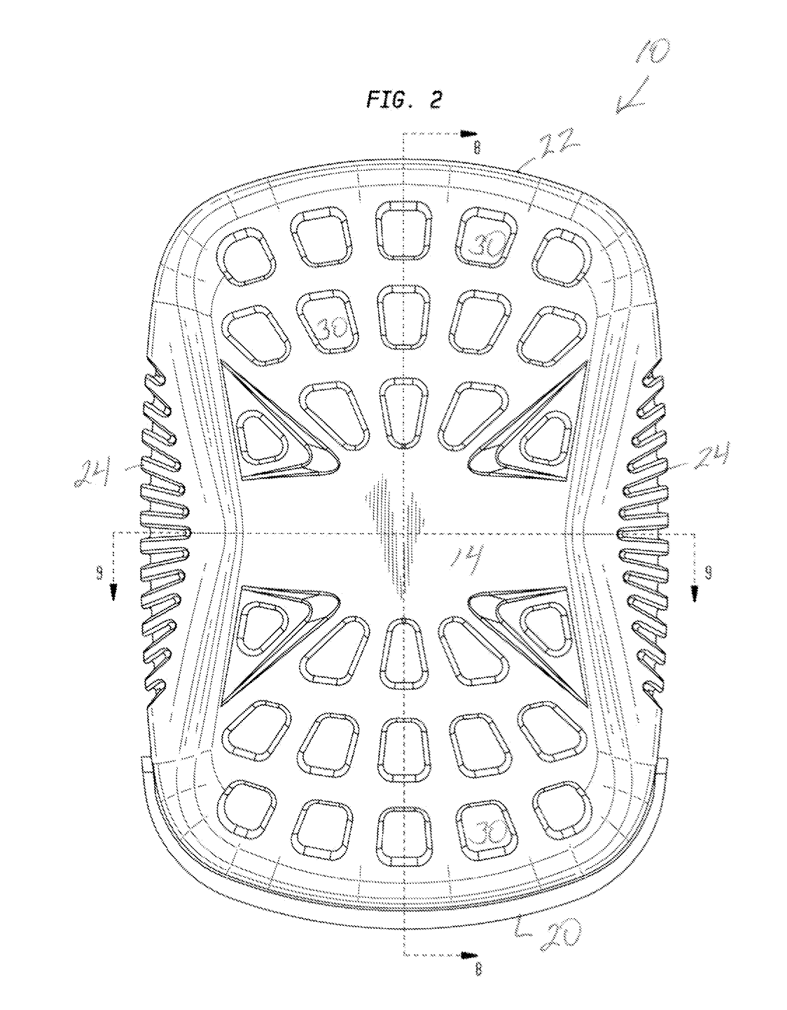

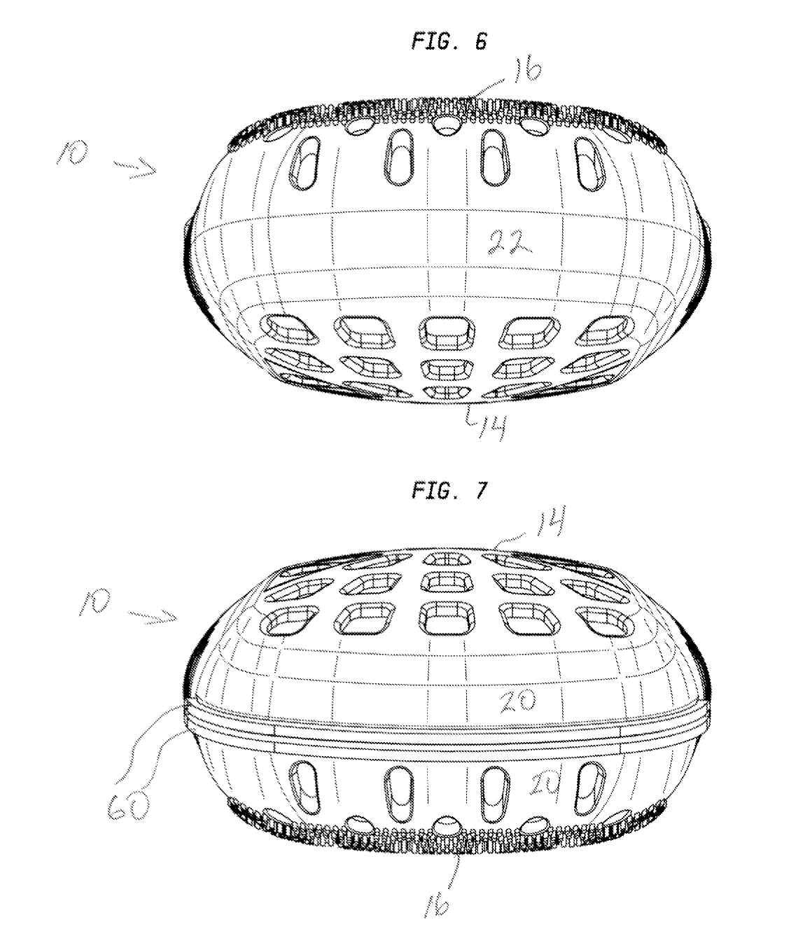

Referring now to the drawings in which like figures represent like elements, FIGS. 1 to 8 depict one embodiment of the inventive cleansing implement. In FIGS. 1 to 8, cleansing implement 10 is made up of a flexible outer shell 12 that contains resilient core 50. Flexible outer shell 12 includes an apertured arcuate first surface 14 having a plurality of apertures 30, a apertured substantially flat second surface 16 having a plurality of apertures 32, axial sides 18, sealable end surface 20 and continuous end surface 22. Axial sides 18 contain gripping elements 24 integrally molded on each axial surface 18. End sides 20 and 22 define apertures 38.

Apertured first surface 14 is formed of a foamed, pliable, resin surrounding apertures 30 and apertured second surface 16 is formed a smooth, non-foamed, pliable, thermoplastic resin surrounding apertures 32.

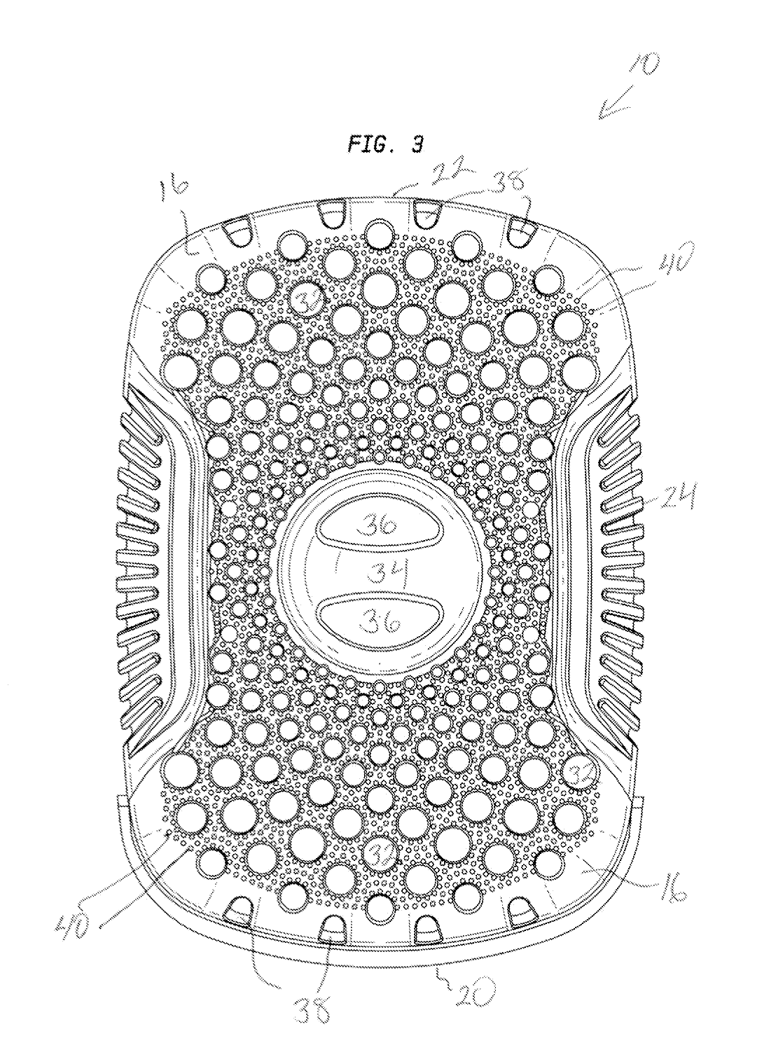

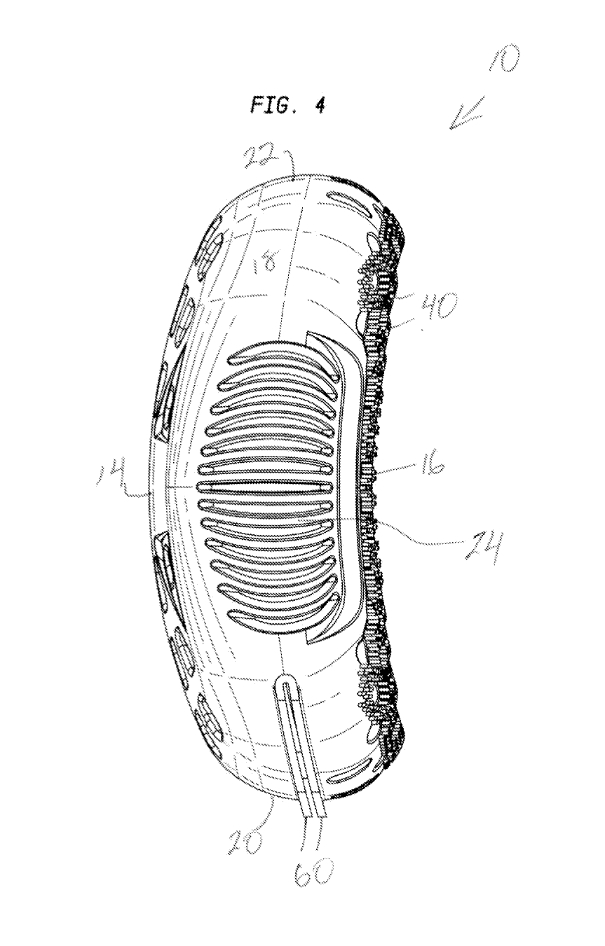

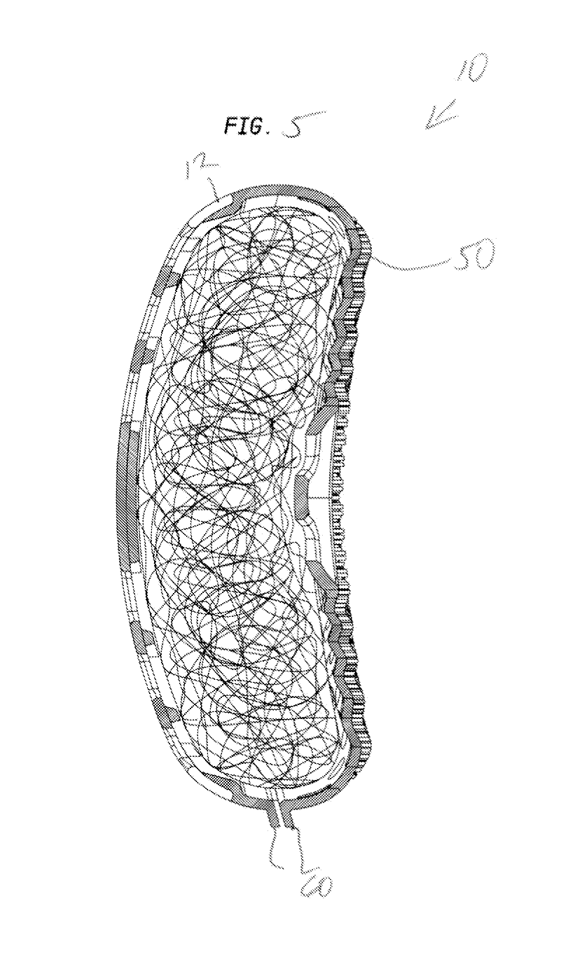

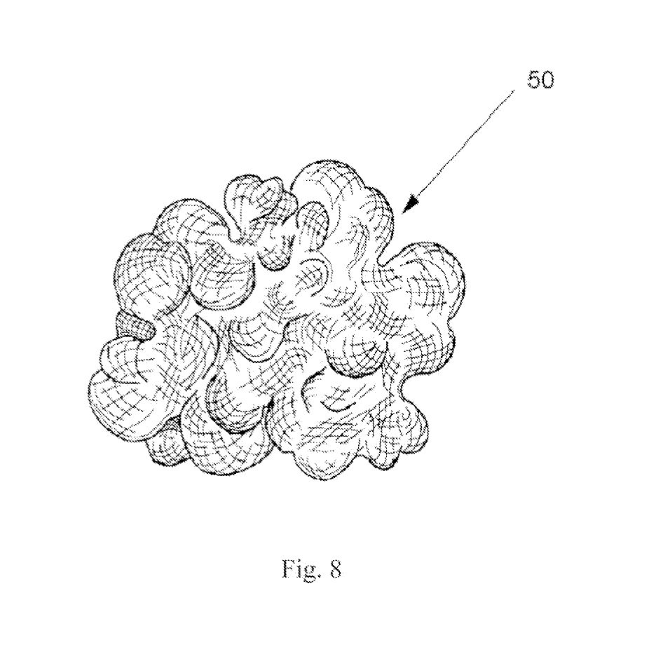

In FIG. 3, apertured second surface 16 defines center well 34 which defines apertures 36. Apetures 36 are preferably larger in area than either apertures 30 or 32. Apertured second surface 16 preferably contains flexible plastic bristles 40 that are preferably molded integrally with surface 16 and surround apertures 32. In FIG. 4, sealing elements 60 are depicted in a sealed configuration. Preferably sealing elements 60 are ultrasonically heat sealed after inserting resilient core 50 into and filling the interior of implement 10. In FIG. 5, after inserting and sealing, resilient core 50 is shown in pressing engagement within flexible outer shell 12. Resilient core 50 provides resistance when implement 10 is squeezed. Preferably resilient core 50 is composed of two or more polymeric mesh sponges, one of which is depicted in FIG. 8, held within flexible outer shell 12.

In use the consumer will dispense liquid body wash into implement 10 by pouring the liquid body wash into well 34 and through apertures 36 whereupon the resilient core 50 will absorb the body wash up to its capacity. Next the consumer will expose the implement 10 to water while squeezing in order to generate lather. Next the consumer will rub the implement via second surface 16 on their skin in the same manner as they would a toilet bar followed by rinsing. In a preferred embodiment, bristles 40 will massage the skin and enhance lather production.

In one aspect of the invention is a cleansing implement for depositing a liquid cleanser on the skin of a user, comprising:
a. an outer shell and a resilient core material held inside and in pressing engagement with the interior of the shell, wherein the shell is composed of a material that is flexible at use temperatures and the core material is composed of polymeric mesh sponge having a plurality of plies of an extruded tubular netting mesh;
b. wherein the shell has a arcuate first surface and an opposed substantially flat second surface, the first and second surfaces each defining a plurality of apertures;
c. wherein the plurality of apertures on the first surface occupy a surface area in the range of about 25 to 75% based on the extent of the total surface area of first surface and the plurality of apertures on the second surface occupies a surface area in the range of about 25 to 75% based on the extent of the total surface area of the second side; and
d. wherein not more than about 70% of the apertures each exceed 40 square mm in area.

Advantageously the number of apertures on the first surface each having an area in the range of about 25 to 50 square mm are in the range of about 25 to 100 in number and the number of apertures on the second surface each having an area of about 25 to 50 square mm are in the range of about 25 to 100 in number.

Preferably the length of the implement along its major axis is less than 15 cm. Preferably the length of the implement along its major axis is less than 14, 13 or 12 cm and greater than 7, 8, 9, or 10 cm. More preferably a plurality of soft plastic bristles orthogonal and attached to the second surface are each about 0.6 mm thick and about 2 mm long substantially surrounding each aperture and the surface of the second surface surrounding the apertures is substantially smooth. Most preferably the second surface has one or more centrally disposed apertures each having a surface area that is larger than the other apertures defined by the second surface. Preferably the second surface is composed of a non-foamed material and first surface is composed of a foamed plastic and a woven mat composite.

In another aspect of the invention is a process of making a cleansing implement including but not limited to the steps of:
a. bonding a flexible foamed plastic sheet with woven fibrous mesh to form a flexible composite sheet;
b. cutting a plurality of apertures in the composite sheet;
c. inserting the composite sheet into a first mold cavity;
d. suspending an inner mold within the first mold cavity and inside of the composite sheet;
e. closing the mold;
f. injecting thermoplastic resin having a Shore A Durometer of at least 15 at a temperature above its melt temperature; and
g. molding the foamed plastic sheet and the thermoplastic resin together to form a flexible shell.

Preferably the inventive process further includes the steps of:
a. opening the injection molder;
b. extracting the implement;
c. removing the inner mould;
d. inserting one or more resilient polymeric mesh sponges to substantially fill and remain in pressing engagement with the inside of the shell; and
e. heat sealing the implement (preferably by ultrasonic welding) to capture the mesh sponges within the shell.

Advantageously at least 10 grams of polymeric mesh sponge are inserted inside the shell. Preferably at least 12, 14, 16, and 18 grams are used. More preferably at least 2 or more separate sponges are employed to make up this total.

In a further aspect of the invention is a method of cleansing the skin or hair including but not limited to the steps of:
a. providing a cleansing implement as described above;
b. adding at least 3 grams of a liquid cleansing composition containing about 8 to 40% by wt. of total lathering surfactant(s) prior to cleansing the skin or hair;
c. adding water to the implement while manually compressing and releasing the implement to transfer a sufficient quantity of cleansing composition to the polymeric mesh sponges to generate lather; and
rubbing and squeezing the implement simultaneously on the skin.

### Flexible Outer Shell

Flexible outer shell 12 is composed of at least two zones of materials having different textures exposed to the touch. First surface 14 includes a foamed plastic with a rough surface finish, preferably a composite with a woven fibrous sheet. The remaining outer shell (second surface 16) is composed of a thermoplastic resin with a molded smooth surface finish.

The flexible outer shell's second surface 16 may be any thermoplastic resin whose physical and processing properties lend themselves to manufacturing washing implements. Flexible outer shell first surface 14 may be any foamed plastic that provides a rough molded surface. Preferably it includes a woven fibrous mat.

### Resilient Mesh

The inventive cleansing implement contains a resilient core held inside the flexible outer shell. A preferred resilient core consists of one or more individual polymeric mesh sponge(s) each comprising a plurality of plies of an extruded tubular netting mesh prepared from nylon or a strong flexible polymer, such as addition polymers of olefin monomers and polyamides of polycarboxylic acids.

Preferably the tubular netting has a maximum transverse expanded diameter of about 8 to 16 inches with the contracted minimum diameter on the order of about ½ inch. The tubular netting is preferably open at both ends so that it can be easily utilized in making the multi-ply netting for the preparation of the scrubbing section. The netting is prepared from fine filaments of polymeric material having a thickness preferably varying from about 10 to 18 mils. The netting is prepared from as many as 50 to 200 such filaments which appear to cross over each other at a 45.degree. angle and are bonded at junction points at intervals varying from about 3/16 to ½ inch, depending upon the type of netting or fabric desired. It is important that the bonding of the filaments at the indicated intervals be of such a nature as to securely attach the filaments together and provide a strong netting for the lather generation. The bonding is preferably accomplished by the extruding technique, heat sealing the filaments together or by use of appropriate adhesives. Additional examples of suitable resilient mesh material are disclosed in U.S. Pat. No. 4,462,135 issued on Jul. 31, 1984 and herein incorporated by reference.

### Lathering Surfactant

The inventive cleansing implement is advantageously used with lathering surfactants. By a “lathering surfactant” is meant a surfactant, which when combined with water and mechanically agitated generates a foam or lather. Preferably, these lathering surfactants should be mild, which means that they must provide sufficient cleansing or detersive benefits but not overly dry the skin or hair, and yet meet the lathering criteria described above.

A wide variety of lathering surfactants is useful herein and include those selected from anionic, nonionic, cationic, and amphoteric surfactants and mixtures thereof.

Among the anionic lathering surfactants useful herein are the following non-limiting examples which include the classes of:
(1) Alkyl benzene sulfonates in which the alkyl group contains from 9 to 15 carbon atoms, preferably 11 to 14 carbon atoms in straight chain or branched chain configuration. Especially preferred is a linear alkyl benzene sulfonate containing about 12 carbon atoms in the alkyl chain.
(2) Alkyl sulfates obtained by sulfating an alcohol having 8 to 22 carbon atoms, preferably 12 to 16 carbon atoms. The alkyl sulfates have the formula ROSO₃₋M⁺ where R is the C₈₋₂₂ alkyl group and M is a mono- and/or divalent cation.
(3) Paraffin sulfonates having 8 to 22 carbon atoms, preferably 12 to 16 carbon atoms, in the alkyl moiety. These surfactants are commercially available as Hostapur SAS from Hoechst Celanese.
(4) Olefin sulfonates having 8 to 22 carbon atoms, preferably 12 to 16 carbon atoms. Most preferred is sodium C₁₄-C₁₆ olefin sulfonate, available as Bioterge AS 40®
(5) Alkyl ether sulfates derived from an alcohol having 8 to 22 carbon atoms, preferably 12 to 16 carbon atoms, ethoxylated with less than 30, preferably less than 12, moles of ethylene oxide. Most preferred is sodium lauryl ether sulfate formed from 1 or 2 moles average ethoxylation, commercially available as e.g. Standopol ES-2®.
(6) Alkyl glyceryl ether sulfonates having 8 to 22 carbon atoms, preferably 12 to 16 carbon atoms, in the alkyl moiety.
(7) Fatty acid ester sulfonates of the formula: R¹CH(SO₃₋M+)CO₂R² where R¹ is straight or branched alkyl from about C₈- to C₁₈, preferably C₁₂ to C₁₆, an R² is straight- or branched alkyl from about C₁ to C₆, preferably primarily C₁, and M+ represents a mono- or divalent cation.
(8) Secondary alcohol sulfates having 6 to 18, preferably 8 to 16 carbon atoms.
(9) Fatty acyl isethionates having from 10 to 22 carbon atoms, with sodium cocoyl isethionate being preferred.
(10) Dialkyl sulfosuccinates wherein the alkyl groups range from 3 to 20 carbon atoms each.
(11) Alkanoyl sarcosinates corresponding to the formula RCON(CH₃)CH₂CH₂CO₂M wherein R is alkyl or alkenyl of about 10 to about 20 carbon atoms and M is a water-soluble cation such as ammonium, sodium, potassium and trialkanolammonium. Most preferred is sodium lauroyl sarcosinate.
(12) Alkyl lactylates wherein the alkyl groups range from 8 to 18 carbon atoms, with sodium lauryl lactylate sold as Pationic 138 C® available from the Patterson Chemical Company as the most preferred.
(13) Taurates having from 8 to 16 carbon atoms, with cocoyl methyl taurate being preferred.
(14) Fatty acid soaps consisting of soluble soaps. Soluble soap is defined as a soap or soap blend having a Krafft point less than or equal to about 40 C. The soluble soap(s) can be selected from the chain length of C6-C14 saturated fatty acid soap(s) and C16-C18 unsaturated and polyunsaturated fatty acid soap(s) or a combination of these fatty acid soaps. These soluble soaps can be derived from coco fatty acid, Babasu fatty acid, palm kernel fatty acid and any other source of unsaturated fatty acid including tallow and vegetable oils and their mixtures.

Nonionic lathering surfactants suitable for the present invention include C₁₀-C₂₀ fatty alcohol or acid hydrophobes condensed with from 2 to 100 moles of ethylene oxide or propylene oxide per mole of hydrophobe; C₂-C₁₀ alkyl phenols condensed with from 2 to 20 moles of alkylene oxides; mono- and di-fatty acid esters of ethylene glycol such as ethylene glycol distearate; fatty acid monoglycerides; sorbitan mono- and di-C₈-C₂₀ fatty acids; and polyoxyethylene sorbitan available as Polysorbate 80 and Tween 80® as well as combinations of any of the above surfactants.

Other useful nonionic surfactants include alkyl polyglycosides, saccharide fatty amides (e.g. methyl gluconamides) as well as long chain tertiary amine oxides. Examples of the latter category are: dimethylododecylamine oxide, oleyldi(2-hydroxyethyl)amine oxide, dimethyloctylamine oxide, dimethyldecylamine oxide, dimethyltetradecylamine oxide, di(20-hydroxyethyl)tetradecylamine oxide, 3-didodecyoxy-2-hydroxypropyldi(3-hydroxypropyl)amine oxide, and dimethylhexadecylamine oxide.

Suitable amphoteric or zwitterionic lathering surfactants for use in the present compositions include those broadly described as derivatives of aliphatic quaternary ammonium, phosphonium, and sulfonium compounds, wherein which the aliphatic radicals can be straight chain or branched, and wherein one of the aliphatic substituents contains about 8 to about 30 carbon atoms and another substituent contains an anionic water-solubilizing group, such as carboxy, sulfonate, sulfate, phosphate, phosphonate, and the like. Classes of zwitterionics include alkylamino sulfonates, alkyl betaines and alkylamido betaines, such as stearamidopropyldimethylamine, diethylaminoethylstearamide, dimethylstearamine, dimethylsoyamine, soyamine, myristylamine, tridecylamine, ethylstearylamine, N-tallowpropane diamine, ethoxylated (5 moles ethylene oxide) stearylamine, dihydroxy ethyl stearylamine, arachidylbehenylamine, and the like. Some suitable betaine surfactants include but are not limited to alkyl betaines, alkyl amidopropyl betaines, alkyl sulphobetaines, alkyl glycinates, alkyl carboxyglycinates, alkyl amphopropionates, alkyl amidopropyl hydroxysultaines, acyl taurates, and acyl glutamates, wherein the alkyl and acyl groups have from 8 to 18 carbon atoms. Non-limiting examples of preferred amphoteric surfactants include cocamidopropyl betaine, sodium cocoamphoacetate, disodium cocoamphodiacetate, cocamidopropyl hydroxysultaine, and sodium cocoamphopropionate, which are particularly suitable as mild-type cleansers for skin and hair.

### Manufacturing Methods

In a preferred embodiment, the cleansing implement of the present invention is manufactured using the following method:

1. Polyurethane foam sheets (obtained from Dingban, Jiangsu China; 20 gms/cubic meter density, 25 mm thickness) are bonded and compressed by vulcanization, at about 130 degrees C., for about 5 minutes, at pressure of 20 T (i.e. 200 KN) with woven polyester mesh into a flatter sheet of 2 mm thickness.
2. The foam sheets are then compressed again (at about 160 degrees C., pressure 20 T, for about 200 seconds into a curved shape.
3. Curved shapes are then die cut to the desired final shape, and the apertures are die cut out.
4. The logo is applied by heat transfer.
5. The foam piece is inserted into the right cavity of an injection molder (Haitian International Holdings Limited)
6. An inner mould is hung inside the cavity, in order to make the implement hollow.
7. The injection moulder is closed and TPR (thermoplastic resin, F125G (Styrene Ethylene Butylene Styrene Block Copolymer), Linhai Xinbo) having a Shore A Durometer of 20, is injected (at 190 degrees C.). This injection captures the edges of the foam so the foam and the TPR are permanently moulded together.
8. The injection moulder is opened, and the tools are pulled out. The inner mould is then pulled out of the TPR piece
9. At this stage, the implement has a top tab on both sides that is about ½″ long.
10. 2 pieces of 9 gram tied polymeric mesh sponge (from Ninghai Yuzhoul Craft Co, LDPE, 3.5″ width) are inserted inside.
11. The top tabs are ultrasonically welded shut using a heat sealing machine (Haitian International Holdings Limited), a temperature of about 200 degrees C. and 2.5 seconds sealing time.
12. The welded top tabs are die cut to a width of approximately 2-3 mm.

Other art recognized methods may be used to manufacture the inventive implement.

Except in the operating and comparative examples, or where otherwise explicitly indicated, all numbers in this description indicating amounts of material ought to be understood as modified by the word “about”.

The following non-limiting examples will more fully illustrate the embodiments of this invention. All parts, percentages and proportions referred to herein and in the appended claims are by weight except for surface area and unless otherwise illustrated.

### Example 1

The lathering performance of the inventive implement illustrated in FIGS. 1-8 and manufactured as described above was compared with a comparative implement and a bar of soap using the experimental protocol and lather test method described below. The body wash used for the test was Axe Phoenix Shower Gel sold by Unilever, Englewood Cliffs, N.J. in the case of the implements. The lather volume results are listed in Tables 1 and 2.

TABLE 1

| | | Run 1 | Run 2 | Run 3 | Ave. Total |
|---|---|---|---|---|---|
| | Implement | (mL) | (mL) | (mL) | (mL) |
| 1 | Inventive (1) | 650 | 650 | 700 | 667 |
| 2 | Inventive (2) | 650 | 750 | 700 | 700 |
| 3 | Comparative (3) | 500 | 550 | 550 | 533 |
| 4 | Irish Spring Soap | 100 | 50 | 100 | 83 |

(1) Implement contained 2 × 5 g nylon mesh sponges inside flexible outer shell.
(2) Implement contained 2 × 7 g nylon mesh sponges inside flexible outer shell.
(3) Comparative - Axe Detailer © Shower tool (sold by Unilever (Englewood Cliffs, NJ) contained 40 g nylon mesh sponge.
(4) Irish Spring Soap ( ©Colgate-Palmolive Company) was used alone.

TABLE 2

| Inventive implement | | Comparative implement | | Comparative implement | |
|---|---|---|---|---|---|
| (1) | | (2)(3) | | (2)(4) | |
| Run | mL | Run | mL | Run | mL |
| 1 | 600 | 1 | 650 | 1 | 250 |
| 2 | 750 | 2 | 600 | 2 | 350 |
| 3 | 700 | 3 | 700 | 3 | 300 |
| 4 | 850 | 4 | 600 | 4 | 450 |
| 5 | 750 | | | | |
| Average | 730 | Average | 750 | Average | 400 |

(1) Implement contained 2 × 5 g nylon mesh sponges (poufs) inside flexible outer shell.
(2) Comparative - Axe Detailer Shower tool sold by Unilever (Englewood Cliffs, NJ).
(3) With squeezing. 400 ml total water volume and 3 mls of Axe Phoenix © Shower Gel body wash.
(4) Without squeezing. 400 ml total water volume and 3 mls of Axe Phoenix © Shower Gel body wash.

### Methods:

### A. Lather Foam Measurement:

1. Thoroughly wet implement in lukewarm water (T=37 C).
2. Squeeze water out by hand.
3. Add 3 ml of cleansing composition directly onto the implement or bar of soap.
4. Allow 400 mL of water to flow through a funnel onto implement or soap bar while scrubbing in a linear motion along a rough surfaced, inclined plane (“wash station”) about once per second.
5. If using the inventive implement, squeeze once with each pass. (comparative implements may be squeezed for additional tests).
6. Place a 1000 ml capacity separation flask with a funnel inlet underneath the wash station to collect any lather that falls.
7. Allow substantially all lather to be collected (usually 1 minute).
8. Open valve at the bottom of the flask to allow any collected water to escape and then close valve.
9. Measure the volume of the lather in beaker.

We claim:

1. A cleansing implement for depositing a liquid cleanser on the skin of a user, comprising:
a. an outer shell and a resilient core material held inside and in pressing engagement with the interior of the shell, wherein the shell is composed of a material that is flexible at use temperatures and the core material is composed of polymeric mesh sponge having a plurality of plies of an extruded tubular netting mesh;
b. wherein the shell has an arcuate first surface and an opposed substantially flat second surface, the first and second surfaces each defining a plurality of apertures;
c. wherein the plurality of apertures on the first surface occupy a surface area in the range of about 25 to 75% based on the extent of the total surface area of first surface and the plurality of apertures on the second surface occupies a surface area in the range of about 25 to 75% based on the extent of the total surface area of the second side; and
d. wherein not more than about 70% of the apertures each exceed 40 square mm in area.

2. The cleansing implement of claim 1 wherein the number of apertures on the first surface each having an area in the range of about 25 to 50 square mm are in the range of about 25 to 100 in number.

3. The cleansing implement of claim 1 wherein the number of apertures on the second surface each having an area of about 25 to 50 square mm are in the range of about 25 to 100 in number.

4. The cleansing implement of claim 1 wherein the length of the implement along its major axis is less than 15 cm.

5. The cleansing implement of claim 1 wherein a plurality of soft plastic bristles orthogonal and attached to the second surface are each about 0.6 mm thick and about 2 mm long substantially surrounding each aperture and the surface of the second surface surrounding the apertures is substantially smooth.

6. The cleansing implement of claim 5 wherein the second surface has one or more centrally disposed apertures each having a surface area that is larger than the other apertures defined by the second surface.

7. The cleansing implement of claim 1 wherein the second surface is composed of a non-foamed material and first surface is composed of a foamed plastic and a woven mat composite.

8. A process of making a cleansing implement comprising the steps:
a. bonding a flexible foamed plastic sheet with woven fibrous mesh to form a flexible composite sheet;
b. cutting a plurality of apertures in the composite sheet;
c. inserting the composite sheet into a first mold cavity;
d. suspending an inner mold within the first mold cavity and inside of the composite sheet;
e. closing the mold;
f. injecting thermoplastic resin having a Shore A Durometer of at least 15 at a temperature above its melt temperature; and
g. molding the foamed plastic sheet and the thermoplastic resin together to form a flexible shell.

9. The process of claim 8 further comprising the steps of:
a. opening the injection molder;
b. extracting the implement;
c. removing the inner mould;
d. inserting one or more resilient polymeric mesh sponges to substantially fill and remain in pressing engagement with the inside of the shell; and
e. heat sealing the implement to capture the mesh sponges within the shell.

10. The process of claim 9 wherein at least 10 grams of polymeric mesh sponge are inserted inside the shell.

11. A method of cleansing the skin or hair comprising the steps of:
a. providing a cleansing implement according to claim 1;
b. adding at least 3 grams of a liquid cleansing composition containing about 8 to 40% by wt. of total lathering surfactant(s) prior to cleansing the skin or hair;
c. adding water to the implement while manually compressing and releasing the implement to transfer a sufficient quantity of cleansing composition to the polymeric mesh sponges to generate lather; and
d. rubbing and squeezing the implement simultaneously on the skin.
